(19) United States
(12) Patent Application Publication
(10) Pub. No.: US 2026/0239230 A1
(43) Pub. Date: Aug. 13, 2026

(54) POWER HEADROOM ESTIMATION FOR MULTI-PANEL SIMULTANEOUS UPLINK TRANSMISSION AND RELATED DEVICES

(71) Applicant: SHENZHEN TCL NEW TECHNOLOGY CO., LTD., Shenzhen, Guangdong (CN)

(72) Inventor: Kai LIU, Shenzhen, Guangdong (CN)

(73) Assignee: SHENZHEN TCL NEW TECHNOLOGY CO., LTD., Shenzhen, Guangdong (CN)

(21) Appl. No.: 19/152,913

(22) PCT Filed: Feb. 1, 2023
(86) PCT No.: PCT/CN2023/074137

§ 371 Date: Jul. 31, 2025

(51) Int. Cl. H04W 52/36; H04W 52/14; H04W 52/42

(52) U.S. Cl. CPC H04W 52/365; H04W 52/146; H04W 52/42

(57) ABSTRACT

A method of estimating power headroom for multi-panel simultaneous uplink transmissions and related devices are provided. The method, performed by a UE, includes being configured more than one panel-specific maximum powers of different panels; and computing power headroom (PH), wherein the PH is a UE-specific PH which is a sum of the panel-specific maximum powers of the panels minus a sum of panel-specific scheduling powers of UL transmissions on the panels, or wherein the PH is a panel-specific PH of one panel which is the panel-specific maximum power of the panel minus the panel-specific scheduling power of the UL transmission on the panel. With this method, power headroom reporting can be achieved for multiple panels performing simultaneous UL transmissions in the UE. In addition, the UE may compute the UE-specific PH or the panel-specific PH for another configuration, e.g., the UE is configured a UE-specific maximum power.

### TECHNICAL FIELD

The present invention relates to wireless communication technologies, and more particularly, to a method of estimating power headroom for multi-panel simultaneous uplink transmissions performed by a user equipment (UE) in a network, a method of receiving power headroom for multi-panel simultaneous uplink transmissions performed by a transmission-reception point (TRP) in a network, and related devices such as a user equipment (UE) and a TRP.

### BACKGROUND ART

Wireless communication systems, such as the third-generation (3G) of mobile telephone standards and technology are well known. Such 3G standards and technology have been developed by the Third Generation Partnership Project (3GPP). The 3rd generation of wireless communications has generally been developed to support macro-cell mobile phone communications. Communication systems and networks have developed towards being a broadband and mobile system. In cellular wireless communication systems, user equipment (UE) is connected by a wireless link to a radio access network (RAN). The RAN includes a set of base stations (BSs) which provide wireless links to the UEs located in cells covered by the base stations, and an interface to a core network (CN) which provides overall network control. The RAN and CN each conducts respective functions in relation to the overall network.

The 3GPP has developed the so-called Long-Term Evolution (LTE) system, namely, an Evolved Universal Mobile Telecommunication System Territorial Radio Access Network (E-UTRAN), for a mobile access network where one or more macro-cells are supported by base station knowns as an eNodeB or eNB (evolved NodeB). More recently, LTE is evolving further towards the so-called 5G or NR (new radio) systems where one or more cells are supported by base stations known as a next generation Node B called gNodeB (gNB).

The 5G New Radio (NR) standard will support a multitude of different services each with very different requirements. These services include Enhanced Mobile Broadband (eMBB) for high data rate transmission, Ultra-Reliable Low Latency Communication (URLLC) for devices requiring low latency and high link reliability and Massive Machine-Type Communication (mMTC) to support a large number of low-power devices for a long life-time requiring highly energy efficient communication.

Multiple-input multiple-output (MIMO) is an effective approach to enhance the capacity of a radio link due to the multiplexing of both transmit and receive antennas. MIMO refers to a practical technique for sending and receiving more than one data signal simultaneously over the same radio channel, which improves the performance of spectral efficiency greatly. Below a quick overview is given about what progress has been achieved to enable the use of multi-TRP transmission which is one of the key technology of MIMO in an efficient manner.

MIMO is one of the key technologies in NR systems and is successful in commercial deployment. In the communication system of MIMO, both UE and base station comprise of a large number of antenna elements. Especially for UE, these antenna elements can be distributed in different panels, as shown in FIG. 1. Each panel is placed at different position such that UE can communicate with base station better.

Power headroom (PH) reports are needed to provide support for power-aware packet scheduling. In NR, two types of reporting are supported: a first one (type 1) for physical uplink shared channel (PUSCH) transmission, a second one (type 3) for Sounding Reference Signal (SRS) transmission. There is no type 2 PH report in NR because simultaneous transmission of PUSCH and physical uplink control channel (PUCCH) is not permitted in NR. While in LTE, type 2 PH is reported for PUSCH and PUCCH transmission.

If a UE determines that a type 1 PH report for an activated serving cell is based on an actual PUSCH transmission, the UE computes the actual PH report as the maximum power of the UE minus the scheduling power of the actual PUSCH transmission. If a UE determines that a type 1 PH report for an activated serving cell is based on a reference PUSCH transmission, the UE computes the virtual PH report as the maximum power of the UE minus the scheduling power of the reference PUSCH transmission.

The PH is reported via medium access control (MAC) signalling. This MAC signalling also contains the maximum power of the UE and the Power Management Maximum Power Reduction (P-MPR) of the UE. The P-MPR indicates how many powers the maximum power should back off to satisfy the maximum permissible exposure (MPE) regulation for FR2, which is set for limiting RF exposure on human body.

In current 3GPP specification, only one panel in a UE can perform a UL transmission on a carrier of a serving cell at the same time in spite of a UE with one or more panels. For a UL transmission, a UE is configured a maximum power and the UE computes a scheduling power of the UL transmission according to the scheduling parameters such as P0, alpha, closed loop index, path loss, physical resource block (PRB) number and so on. For a PH, the UE only needs to compute the PH of a UL transmission on this panel. It should be noted that the UE reports a PH for single TRP scenario or reports two PHs for multi-TRP scenario. Meanwhile, the UE only needs to report a maximum power and a P-MPR.

In 3GPP Release 18 WID, it is introduced that multiple panels in a UE can perform UL transmissions simultaneously. There are two issues should be solved. The first one is related to the computation of the PH(s). The second one is related to the report of the PH(s), the maximum power(s), P-MPR(s).

### SUMMARY

The objective of the present invention is to provide a method of estimating power headroom for multi-panel simultaneous uplink transmissions performed by a user equipment (UE) in a network, a method of receiving power headroom for multi-panel simultaneous uplink transmissions performed by a transmission-reception point (TRP) in a network, and related devices for solving issues in the prior arts, achieving power headroom reporting for multiple panels performing simultaneous UL, or providing a good communication performance.

In a first aspect, an embodiment of the present invention provides a method of estimating power headroom for multi-panel simultaneous uplink transmissions, performed by a user equipment (UE) in a network, the method includes: being configured more than one panel-specific maximum powers of different panels; and computing power headroom (PH), wherein the PH is a UE-specific PH which is a sum of the panel-specific maximum powers of the panels minus a sum of panel-specific scheduling powers of uplink (UL) transmissions on the panels, or wherein the PH is a panel-specific PH of one panel which is the panel-specific maximum power of the panel minus the panel-specific scheduling power of the UL transmission on the panel.

In a second aspect, an embodiment of the present invention provides a method of estimating power headroom for multi-panel simultaneous uplink transmissions, performed by a user equipment (UE) in a network, the method includes: being configured a UE-specific maximum power; and computing power headroom (PH), wherein the PH is a UE-specific PH which is the UE-specific maximum power minus a sum of panel-specific scheduling powers of uplink (UL) transmissions on the panels, or wherein the PH is a panel-specific PH of one panel which is the UE-specific maximum power minus the panel-specific scheduling power of the UL transmission on the panel.

In a third aspect, an embodiment of the present invention provides a method of receiving power headroom for multi-panel simultaneous uplink transmissions, performed by a transmission-reception point (TRP) in a network, the method including: receiving power headroom (PH) reported by a user equipment (UE) based on more than one panel-specific maximum powers of different panels, wherein the PH is a UE-specific PH which is a sum of the panel-specific maximum powers of the panels minus a sum of panel-specific scheduling powers of uplink (UL) transmissions on the panels, or wherein the PH is a panel-specific PH of one panel which is the panel-specific maximum power of the panel minus the panel-specific scheduling power of the UL transmission on the panel.

In a fourth aspect, an embodiment of the present invention provides a method of receiving power headroom for multi-panel simultaneous uplink transmissions, performed by a transmission-reception point (TRP) in a network, the method including: receiving power headroom (PH) reported by a user equipment (UE) based on a UE-specific maximum power, wherein the PH is a UE-specific PH which is the UE-specific maximum power minus a sum of panel-specific scheduling powers of uplink (UL) transmissions on the panels, or wherein the PH is a panel-specific PH of one panel which is the UE-specific maximum power minus the panel-specific scheduling power of the UL transmission on the panel.

In a fifth aspect, an embodiment of the present invention provides a method of power headroom reporting for multi-panel simultaneous uplink transmissions, performed by a user equipment (UE) in a network, the method including: being configured more than one panel-specific maximum powers of different panels; and reporting one UE-specific PH of the UE or more than one panel-specific PHs of the different panels to the network, wherein the UE-specific PH is a sum of the panel-specific maximum powers of the panels minus a sum of panel-specific scheduling powers of uplink (UL) transmissions on the panels, or wherein the panel-specific PH is the panel-specific maximum power of the panel minus the panel-specific scheduling power of the UL transmission on the panel.

In a sixth aspect, an embodiment of the present invention provides a method of power headroom reporting for multi-panel simultaneous uplink transmissions, performed by a user equipment (UE) in a network, the method including: being configured a UE-specific maximum power; and reporting one UE-specific PH of the UE or more than one panel-specific PHs of the different panels to the network, wherein the UE-specific PH is the UE-specific maximum power minus a sum of panel-specific scheduling powers of uplink (UL) transmissions on the panels, or wherein the panel-specific PH is the UE-specific maximum power minus the panel-specific scheduling power of the UL transmission on the panel.

In a seventh aspect, an embodiment of the present invention provides a UE, including a processor and a transmitter, wherein the processor is configured to call and run program instructions stored in a memory, to execute the method of any of the first aspect and the second aspect.

In an eighth aspect, an embodiment of the present invention provides a TRP, including a processor and a transmitter, wherein the processor is configured to call and run program instructions stored in a memory, to execute the method of any of the third aspect and the fourth aspect.

In a ninth aspect, an embodiment of the present invention provides a computer readable storage medium provided for storing a computer program, which enables a computer to execute the method of any of the first to the fourth aspects.

In a tenth aspect, an embodiment of the present invention provides a computer program product, which includes computer program instructions enabling a computer to execute the method of any of the first to the fourth aspects.

In an eleventh aspect, an embodiment of the present invention provides a computer program, when running on a computer, enabling the computer to execute the method of any of the first to the fourth aspects.

### DESCRIPTION OF DRAWINGS

In order to more clearly illustrate the embodiments of the present invention or related art, the following figures that will be described in the embodiments are briefly introduced. It is obvious that the drawings are merely some embodiments of the present invention, a person having ordinary skill in this field can obtain other figures according to these figures without paying the premise.

FIG. 1 is a schematic diagram illustrating a multi-TRP scenario.

FIG. 2 is a schematic block diagram illustrating a communication network system according to an embodiment of the present invention.

FIG. 3 is a schematic diagram illustrating radio protocol architecture within TRP (or gNB) and UE.

FIG. 4 is a schematic diagram illustrating a gNB further including a centralized unit (CU) and a plurality of distributed unit (DUs).

FIG. 5 is a flowchart of a method of estimating power headroom for multi-panel simultaneous uplink transmissions according to a first embodiment of the present invention.

FIG. 6 is a flowchart of a method of estimating power headroom for multi-panel simultaneous uplink transmissions according to a second embodiment of the present invention.

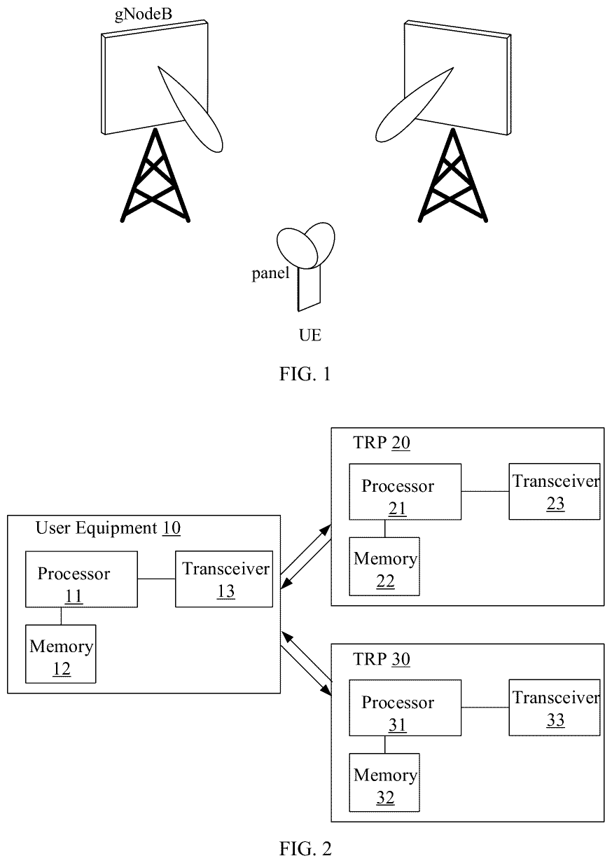

### DETAILED DESCRIPTION OF EMBODIMENTS

Embodiments of the disclosure are described in detail with the technical matters, structural features, achieved objects, and effects with reference to the accompanying drawings as follows. Specifically, the terminologies in the embodiments of the present invention are merely for describing the purpose of the certain embodiment, but not to limit the invention.

In this document, the term “/” should be interpreted to indicate “and/or.” A combination such as “at least one of A, B, or C,” “one or more of A, B, or C,” “at least one of A, B, and C,” “one or more of A, B, and C,” or “A, B, and/or C” may be A only, B only, C only, A and B, A and 30 C, B and C, or A and B and C, where any combination may contain one or more members of A, B, or C.

The present invention is related to wireless communication systems operating in multiple-input multiple-output (MIMO) systems. More specifically, the target is to provide some solutions to the computation of power headroom (PH) and the report of the PH, maximum power and power management maximum power reduction (P-MPR) for multiple panels performing simultaneous uplink (UL) transmissions in a user equipment (UE). In addition, an associated transmission-reception point (TRP) or base station (BS) (e.g., gNB) is also provided.

For the computation of the power headroom (PH), the UE can compute the UE-specific PH or the panel-specific PH for difference configurations. For the report of the PH, the maximum power and the P-MPR, the UE can report the UE-specific PH, maximum power and P-MPR, or the panel-specific PH, maximum power and P-MPR, or any combination of them for difference configurations.

The present invention can be summarized as follows, but is not limited thereto:
1. The computation of the UE-specific PH or the panel-specific PH for difference configurations are proposed.
2. The report of the UE-specific PH, maximum power and P-MPR, or the panel-specific PH, maximum power and P-MPR, or any combination of them for difference configurations are proposed.
3. Different Media Access Control Control Elements (MAC CEs) for different report requirements are designed.

FIG. 2 illustrates that, in some embodiments, one or more user equipments (UEs) 10, a first transmission/reception point (TRP) 20 and a second TRP 30 for wireless communication in a communication network system according to an embodiment of the present invention are provided. The communication network system includes the one or more UEs 10, the first TRP 20 and the second TRP 30. The one or more UEs 10 may include a memory 12, a transceiver 13, and a processor 11 coupled to the memory 12 and the transceiver 13. The first TRP 20 may include a memory 22, a transceiver 23, and a processor 21 coupled to the memory 22 and the transceiver 23. The second TRP 30 may include a memory 32, a transceiver 33, and a processor 31 coupled to the memory 32 and the transceiver 33. The processor 11 or 21 or 31 may be configured to implement proposed functions, procedures and/or methods described in this description. Layers of radio interface protocol may be implemented in the processor 11 or 21 or 31. The memory 12 or 22 or 32 is operatively coupled with the processor 11 or 21 or 31 and stores a variety of information to operate the processor 11 or 21 or 31. The transceiver 13 or 23 or 33 is operatively coupled with the processor 11 or 21 or 31, and the transceiver 13 or 23 or 33 transmits and/or receives a radio signal. The first TRP 20 (and the second TRP 30) and a next generation core network (5GCN) may also communicate with each other either wirelessly or in a wired way. When the communication network system complies with the New Radio (NR) standard of the 3rd Generation Partnership Project (3GPP), the next generation core network is a backend serving network system and may include an Access and Mobility Management Function (AMF), User Plane Function (UPF), and a Session Management Function (SMF). In one aspect, the user equipment can include almost any consumer electronic device or appliance that can connect to a radio access network and a core network for the releases of 3GPP and further, such as, but not limited to NR networks.

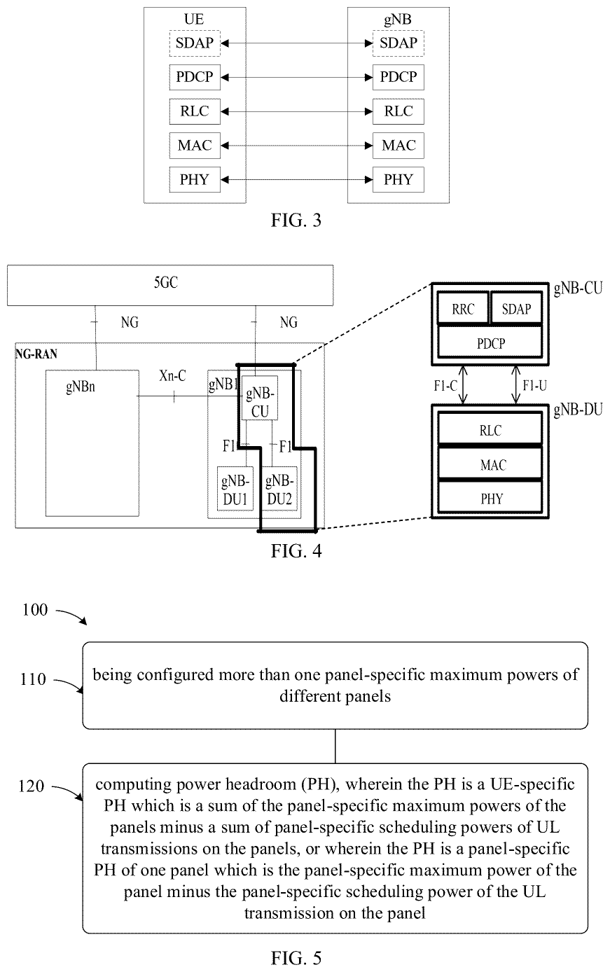

The processor 11 or 21 or 31 may include application-specific integrated circuit (ASIC), other chipset, logic circuit and/or data processing device. The memory 12 or 22 or 32 may include read-only memory (ROM), random access memory (RAM), flash memory, memory card, storage medium and/or other storage device. The transceiver 13 or 23 or 33 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 or 32 and executed by the processor 11 or 21 or 31. The memory 12 or 22 or 32 can be implemented within the processor 11 or 21 or 31 or external to the processor 11 or 21 or 31 in which case those can be communicatively coupled to the processor 11 or 21 or 31 via various means as is known in the art. The user plane radio protocol architecture within the TRP (or gNB) and UE is shown in FIG. 3, which includes optional Service Data Adaptation Protocol (SDAP), Packet Data Convergence Protocol (PDCP), Radio Link Control (RLC), Medium Access Control (MAC). In RAN functional split, a gNB further includes a centralized unit (CU) and a plurality of distributed unit (DUs) as shown in FIG. 4. The protocol stack of CU includes an RRC layer, an optional SDAP layer, and a PDCP layer, while the protocol stack of DU includes an RLC layer, a MAC layer, and a PHY layer. The F1 interface between the CU and DU is established between the PDCP layer and the RLC layer.

FIG. 5 is a flowchart of a method of estimating power headroom for multi-panel simultaneous uplink transmissions according to a first embodiment of the present invention. Referring to FIG. 5 in conjunction with FIG. 2, the method 100 is performed by a user equipment (UE) and includes the followings. In Step 110, the UE is configured more than one panel-specific maximum powers of different panels. The panel-specific maximum power is a maximum power specific to each panel. This configuration may be preconfigured or self-contained. In Step 120, with this configuration, the UE computes power headroom (PH). The power headroom indicates how much transmission power left for the UE to use in addition to the power being used by current transmission. Specifically, the PH is a UE-specific PH which is a sum of the panel-specific maximum powers of the panels minus a sum of panel-specific scheduling powers of uplink (UL) transmissions on the panels, or the PH is a panel-specific PH of one panel which is the panel-specific maximum power of the panel minus the panel-specific scheduling power of the UL transmission on the panel. After the PH is computed, the UE may perform power headroom report to a transmission-reception point (TRP) or a base station (BS). With this method, power headroom reporting can be achieved for multiple panels performing simultaneous UL transmissions in the UE.

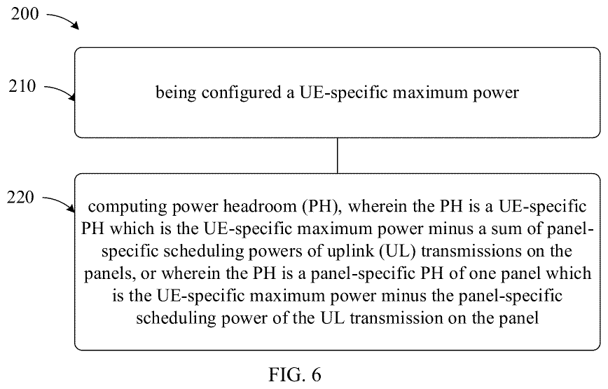

FIG. 6 is a flowchart of a method of estimating power headroom for multi-panel simultaneous uplink transmissions according to a second embodiment of the present invention. Referring to FIG. 6 in conjunction with FIG. 2, the method 200 is performed by a user equipment (UE) and includes the followings. In Step 210, the UE is configured a UE-specific maximum power. The UE-specific maximum power is a maximum power specific to a UE. This configuration may be preconfigured or self-contained. In Step 220, with this configuration, the UE computes power headroom (PH). The power headroom indicates how much transmission power left for the UE to use in addition to the power being used by current transmission. Specifically, the PH is a UE-specific PH which is the UE-specific maximum power minus a sum of panel-specific scheduling powers of uplink (UL) transmissions on the panels, or the PH is a panel-specific PH of one panel which is the UE-specific maximum power minus the panel-specific scheduling power of the UL transmission on the panel. After the PH is computed, the UE may perform power headroom report to a transmission-reception point (TRP) or a base station (BS). With this method, power headroom reporting can be achieved for multiple panels performing simultaneous UL transmissions in the UE.

In a first aspect of the present invention, it is proposed how to compute a UE-specific power headroom (PH) or a panel-specific PH.
Configuration 1: A UE is configured more than one (e.g., two) panel-specific maximum powers of different panels.

An actual UE-specific PH of a UE is based on actual UL transmissions on the panels. The actual UE-specific PH computed by the UE is the sum of the panel-specific maximum powers of the panels minus the sum of the panel-specific scheduling powers of the actual UL transmissions. A panel-specific scheduling power of an actual UL transmission is computed according to the scheduling parameters of the actual UL transmission, such as the target power, the number of RBs, the path loss compensation factor, the path loss, the power offset, the closed loop control adjust and so on. A virtual UE-specific PH of a panel is based on a reference UL transmission on the panel. The virtual UE-specific PH computed by the UE which is the sum of the virtual panel-specific maximum powers of the panels minus the sum of the panel-specific scheduling powers of the reference UL transmissions. A virtual panel-specific maximum power of the panel is computed assuming that various types of Maximum Power Reduction (MPR) are zero. A panel-specific scheduling power of a reference UL transmission is computed according to the scheduling parameters of the reference UL transmission, such as the target power, the path loss compensation factor, the path loss, the closed loop control adjust and so on.

An actual panel-specific PH of a panel is based on an actual UL transmission on the panel. The actual panel-specific PH computed by the UE which is the panel-specific maximum power of the panel minus the panel-specific scheduling power of the actual UL transmission. A panel-specific scheduling power of an actual UL transmission is computed according to the scheduling parameters of the actual UL transmission, such as the target power, the number of RBs, the path loss compensation factor, the path loss, the power offset, the closed loop control adjust and so on. A virtual panel-specific PH of a panel is based on a reference UL transmission on the panel. The virtual panel-specific PH computed by the UE which is the virtual panel-specific maximum power of the panel minus the panel-specific scheduling power of the reference UL transmission. A virtual panel-specific maximum power of the panel is computed assuming that various types of Maximum Power Reduction (MPR) are zero. A panel-specific scheduling power of a reference UL transmission is computed according to the scheduling parameters of the reference UL transmission, such as the target power, the path loss compensation factor, the path loss, the closed loop control adjust and so on.
Configuration 2: A UE is configured a UE-specific maximum power.

An actual UE-specific PH of a UE is based on actual UL transmissions on the panels. The actual UE-specific PH computed by the UE is the UE-specific maximum power minus the sum of the panel-specific scheduling powers of the actual UL transmissions. A panel-specific scheduling power of an actual UL transmission is computed according to the scheduling parameters of the actual UL transmission, such as the target power, the number of RBs, the path loss compensation factor, the path loss, the power offset, the closed loop control adjust and so on. A virtual UE-specific PH of a UE is based on reference UL transmissions on the panels. The virtual UE-specific PH computed by the UE which is the virtual UE-specific maximum power minus the sum of the panel-specific scheduling powers of the reference UL transmissions. The virtual UE-specific maximum power is computed assuming that various types of Maximum Power Reduction (MPR) are zero. A panel-specific scheduling power of a reference UL transmission is computed according to the scheduling parameters of the reference UL transmission, such as the target power, the path loss compensation factor, the path loss, the closed loop control adjust and so on.

An actual panel-specific PH of a UE is based on an actual UL transmission on the panel. The actual panel-specific PH computed by the UE is the UE-specific maximum power minus the panel-specific scheduling power of the actual UL transmission. A panel-specific scheduling power of an actual UL transmission is computed according to the scheduling parameters of the actual UL transmission, such as the target power, the number of RBs, the path loss compensation factor, the path loss, the power offset, the closed loop control adjust and so on. A virtual panel-specific PH of a UE is based on reference UL transmissions on the panels. The virtual panel-specific PH computed by the UE which is the virtual UE-specific maximum power minus the panel-specific scheduling power of the reference UL transmission. The virtual UE-specific maximum power is computed assuming that various types of Maximum Power Reduction (MPR) are zero. A panel-specific scheduling power of a reference UL transmission is computed according to the scheduling parameters of the reference UL transmission, such as the target power, the path loss compensation factor, the path loss, the closed loop control adjust and so on.

In a second aspect of the present invention, it is proposed how to report a UE-specific PH or panel-specific PHs.
Configuration 1: A UE is configured more than panel-specific maximum powers of more than panels.

In a first alternative embodiment, one UE-specific PH of the UE is reported to network. For example, only one actual UE-specific PH based on actual UL transmissions or only one virtual UE-specific PH based on reference UL transmissions is reported to network.

In a second alternative embodiment, more than one (e.g., two) panel-specific PHs of the different panels are reported to network. The panel-specific PHs may be actual panel-specific PHs, or virtual panel-specific PHs, or a combination of them.
Configuration 2: A UE is configured a UE-specific maximum power.

In a first alternative embodiment, one UE-specific PH of the UE is reported to network. For example, only one actual UE-specific PH based on actual UL transmissions or only one virtual UE-specific PH based on reference UL transmissions is reported to network.

In a second alternative embodiment, more than one (e.g., two) panel-specific PHs of the different panels are reported to network. The panel-specific PHs may be actual panel-specific PHs, or virtual panel-specific PHs, or a combination of them.

In a third aspect of the present invention, it is proposed how to report a UE-specific P-MPR or panel-specific P-MPRs.
Configuration 1: A UE is configured more than one (e.g., two) panel-specific maximum powers of different panels.

In a first alternative embodiment, one UE-specific P-MPR of the UE is reported to network. Network can know that the actual transmission power of the UE cannot be more than the sum of the panel-specific maximum powers of the different panels minus the UE-specific P-MPR.

In a second alternative embodiment, one panel-specific P-MPR of the panel is reported to network. The panel-specific P-MPRs of the other panels are not reported. Network can know that the actual transmission power of the panel cannot be more than the panel-specific maximum power of the panel minus the panel-specific P-MPR of the panel and the actual transmission power of the other panels cannot be more than the panel-specific maximum power of the other panels. For example, the UE has two panels, e.g., Panel-1 and Panel-2. If the panel-specific P-MPR of Panel-1 is reported, network knows that the panel-specific maximum power of Panel-1 minus the panel-specific P-MPR of Panel-1 is the power left for transmission on Panel-1.

In a third alternative embodiment, more than one (e.g., two) panel-specific P-MPRs of the different panels are reported to network. Network can know that each actual transmission power of each panel cannot be more than each panel-specific maximum power of each panel minus each panel-specific P-MPR of each panel. For example, in case of three panels, e.g., Panel-1, Panel-2 and Panel-3. If the panel-specific P-MPRs of Panel-1 and Panel-2 are reported, network knows that the panel-specific maximum power of Panel-1 minus the panel-specific P-MPR of Panel-1 is the power left for transmission on Panel-1, and the panel-specific maximum power of Panel-2 minus the panel-specific P-MPR of Panel-2 is the power left for transmission on Panel-2.
Configuration 2: A UE is configured a UE-specific maximum power.

In a first alternative embodiment, one UE-specific P-MPR of the UE is reported to network. Network can know that the actual transmission power of the UE cannot be more than the UE-specific maximum power minus the UE-specific P-MPR.

In a second alternative embodiment, one panel-specific P-MPR of the panel is reported to network. The panel-specific P-MPRs of the other panels are not reported. Network can know that the actual transmission power of the UE cannot be more than the UE-specific maximum power minus the panel-specific P-MPR of the panel. If the power overflows, the UE decreases the power of the panel while does not decrease the power of the other panels. For example, the UE has two panels, e.g., Panel-1 and Panel-2. If the panel-specific P-MPR of Panel-1 is reported, network knows that the UE-specific maximum power minus the panel-specific P-MPR of Panel-1 is the power left for UE transmission.

In a third alternative embodiment, more than one (e.g., two) panel-specific P-MPRs of the two panels are reported to network. Network can know that the actual transmission power of the UE cannot be more than the UE-specific maximum power minus the sum of the panel-specific P-MPRs of the different panels. For example, in case of three panels, e.g., Panel-1, Panel-2 and Panel-3. If the panel-specific P-MPRs of Panel-1 and Panel-2 are reported, network knows that the UE-specific maximum power minus the sum of the panel-specific P-MPRs of Panel-1 and Panel-2 is the power left for UE transmission.

In a fourth aspect of the present invention, it is proposed how to report a UE-specific maximum power or panel-specific maximum powers.
Configuration 1: A UE is configured more than one (e.g., two) panel-specific maximum powers of different panels.

In a first alternative embodiment, one UE-specific maximum power of the UE is reported to network. The UE-specific maximum power equals to the sum of the panel-specific maximum powers of the different panels.

In a second alternative embodiment, more than one (e.g., two) panel-specific maximum powers of the different panels are reported to network. If the panel-specific maximum powers of the different panels are equal, one of them can be reported. If all the panel-specific maximum powers associated to the UE are reported, network may know that UE-specific maximum power of the UE by suming up all the panel-specific maximum powers. In addition, the panel-specific maximum power may be a actual panel-specific maximum power based on actual UL transmission, or a virtual panel-specific maximum power based on reference UL transmission.
Configuration 2: A UE is configured a UE-specific maximum power.

In a first alternative embodiment, one UE-specific maximum power of the UE is reported to network.

In a second alternative embodiment, one panel-specific maximum power of the panel is reported to network. The panel-specific maximum power can be a part of the UE-specific maximum power. In addition, the panel-specific maximum power may be a actual panel-specific maximum power based on actual UL transmission, or a virtual panel-specific maximum power based on reference UL transmission.

In a fifth aspect of the present invention, it is proposed the design of MAC CE.

The contents of the MAC CE include at least one of the followings:

The UE-specific maximum power or the panel-specific maximum power(s).

The UE-specific PH or the panel-specific PH(s).

The PH type indication(s) indicating whether the PH is actual or virtual.

The UE-specific P-MPR or the panel-specific P-MPR(s).

The P-MPR indication(s) indicating whether the P-MPR is enabled or not.

Examples of MAC CE pattern are shown in the followings. PH_{UE} or PHₚₐₙₑₗᵢ is the UE-specific PH of the UE or the panel-specific PH of the panel i, respectively. P_{cmax, UE} or P_{cmax,paneli} is the UE-specific maximum power of the UE or the panel-specific maximum power of the panel i, respectively. P-MPR_{UE} or P-MPRₚₐₙₑₗᵢ is the UE-specific P-MPR of the UE or the panel-specific P-MPR of the panel i, respectively. V indicates whether the corresponding PH is actual or virtual. P indicates whether the P-MPR is enabled or not.

### First Alternative Embodiment

| | | |
|---|---|---|
| P | V₁ | PHₚₐₙₑₗ₁ |
| R | V₂ | PHₚₐₙₑₗ₂ |

| | |
|---|---|
| P-MPRₚₐₙₑₗ₁ or R | P_{cmax, panel1} |
| P-MPRₚₐₙₑₗ₂ or R | P_{cmax, panel2} |

### Second Alternative Embodiment

| | | |
|---|---|---|
| P | V₁ | PHₚₐₙₑₗ₁ |
| R | V₂ | PHₚₐₙₑₗ₂ |

| | |
|---|---|
| P-MPR_{UE} or R | P_{cmax, panel1} |
| R | P_{cmax, panel2} |

### Third Alternative Embodiment

| | | |
|---|---|---|
| P | V₁ | PHₚₐₙₑₗ₁ |
| R | V₂ | PHₚₐₙₑₗ₂ |

| | |
|---|---|
| P-MPR_{UE} or R | P_{UE} |

### Fourth Alternative Embodiment

| | | |
|---|---|---|
| P | V | PH_{UE} |

| | |
|---|---|
| P-MPRₚₐₙₑₗ₁ or R | P_{cmax, panel1} |
| P-MPRₚₐₙₑₗ₂ or R | P_{cmax, panel2} |

### Fifth Alternative Embodiment

| | | |
|---|---|---|
| P | V | PH_{UE} |

| | |
|---|---|
| P-MPRₚₐₙₑₗ₁ or R | P_{cmax, UE} |
| P-MPRₚₐₙₑₗ₂ or R | R |

### Sixth Alternative Embodiment

| | | |
|---|---|---|
| P | V | PH_{UE} |

| | |
|---|---|
| P-MPRₚₐₙₑₗ₁ or R | P_{cmax, UE} |
| P-MPRₚₐₙₑₗ₂ or R | R |

### Seventh Alternative Embodiment

| | | |
|---|---|---|
| P | V | PH_{UE} |

| | |
|---|---|
| P-MPR_{UE} or R | P_{cmax, UE} |

### Eighth Alternative Embodiment

| | | |
|---|---|---|
| P | V | PH_{UE} |

| | |
|---|---|
| P-MPRₚₐₙₑₗ₁ or R | P_{cmax, panel1} |
| P-MPRₚₐₙₑₗ₂ or R | P_{cmax, panel2} |

Commercial interests for some embodiments are as follows. 1. Solving issues in the prior art. 2. Achieving the report of the PH, the maximum power and the P-MPR. 3. Achieving power headroom reporting for multiple panels performing simultaneous UL. 4. Providing a good communication performance. Some embodiments of the present invention are used by 5G-NR chipset vendors, V2X communication system development vendors, automakers including cars, trains, trucks, buses, bicycles, moto-bikes, helmets, and etc., drones (unmanned aerial vehicles), smartphone makers, communication devices for public safety use, AR/VR device maker for example gaming, conference/seminar, education purposes. Some embodiments of the present invention are a combination of “techniques/processes” that can be adopted in 3GPP specification to create an end product. Some embodiments of the present invention could be adopted in the 5G NR unlicensed band communications. Some embodiments of the present invention propose technical mechanisms.

The embodiment of the present invention further provides a computer readable storage medium for storing a computer program. The computer readable storage medium enables a computer to execute corresponding processes implemented by the UE/base station (BS)/TRP in each of the methods of the embodiment of the present invention. For brevity, details will not be described herein again.

The embodiment of the present invention further provides a computer program product including computer program instructions. The computer program product enables a computer to execute corresponding processes implemented by the UE/BS/TRP in each of the methods of the embodiment of the present invention. For brevity, details will not be described herein again.

The embodiment of the present invention further provides a computer program. The computer program enables a computer to execute corresponding processes implemented by the UE/BS/TRP in each of the methods of the embodiment of the present invention. For brevity, details will not be described herein again.

The non-transitory computer readable medium may include at least one from a group consisting of: a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory. In an embodiment where the elements are implemented using software, the software may be stored in a computer-readable medium and loaded into computing system using, for example, removable storage drive. A control module (in this example, software instructions or executable computer program code), when executed by the processor in the computer system, causes a processor to perform the functions of the invention as described herein.

Furthermore, the inventive concept can be applied to any circuit for performing signal processing functionality within a network element. It is further envisaged that, for example, a semiconductor manufacturer may employ the inventive concept in a design of a stand-alone device, such as a microcontroller of a digital signal processor (DSP), or application-specific integrated circuit (ASIC) and/or any other sub-system element.

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different approaches to implement the described functions for each particular application, but it should not be considered that the implementation goes beyond the scope of the present invention.

While the present invention has been described in connection with what is considered the most practical and preferred embodiments, it is understood that the present invention is not limited to the disclosed embodiments but is intended to cover various arrangements made without departing from the scope of the broadest interpretation of the appended claims.

1. A method of estimating power headroom for multi-panel simultaneous uplink transmissions, performed by a user equipment (UE) in a network, the method comprising:
being configured more than one panel-specific maximum powers of different panels; and
computing power headroom (PH),
wherein the PH is a UE-specific PH which is a sum of the panel-specific maximum powers of the panels minus a sum of panel-specific scheduling powers of uplink (UL) transmissions on the panels, or wherein the PH is a panel-specific PH of one panel which is the panel-specific maximum power of the panel minus the panel-specific scheduling power of the UL transmission on the panel.

2. The method of claim 1, wherein the UE-specific PH is an actual UE-specific PH which is the sum of the panel-specific maximum powers of the panels minus the sum of the panel-specific scheduling powers of actual UL transmissions on the panels.

3. The method of claim 2, wherein each one of the panel-specific scheduling powers for one actual UL transmission is computed according to scheduling parameters of the one actual UL transmission.

4. The method of claim 1, wherein the UE-specific PH is a virtual UE-specific PH which is the sum of virtual panel-specific maximum powers of the panels minus the sum of the panel-specific scheduling powers of reference UL transmissions on the panels.

5. The method of claim 4, wherein each one of the virtual panel-specific maximum powers for one panel is computed assuming that various types of Maximum Power Reduction (MPR) are zero, and each one of the panel-specific scheduling powers for one reference UL transmission is computed according to scheduling parameters of the one reference UL transmission.

6. The method of claim 1, wherein the panel-specific PH is an actual panel-specific PH which is the panel-specific maximum power of the panel minus the panel-specific scheduling power of actual UL transmission on the panel, or
wherein the panel-specific PH is a virtual panel-specific PH which is a virtual panel-specific maximum power of the panel minus the panel-specific scheduling power of reference UL transmission on the panel.

7. The method of claim 1, further comprising:
reporting one UE-specific PH of the UE to the network; or
reporting more than one panel-specific PHs of the different panels to the network.

8. The method of claim 1, further comprising:
reporting one UE-specific maximum power of the UE to the network, wherein the UE-specific maximum power equals to the sum of the panel-specific maximum powers of the different panels; or
reporting more than one panel-specific maximum powers of the different panels to the network, wherein if the panel-specific PHs of the different panels are equal, one of the panel-specific PHs is reported.

9. The method of claim 1, further comprising:
reporting one UE-specific Power Management Maximum Power Reduction (P-MPR) of the UE to the network; or
reporting one panel-specific P-MPR of the panel to the network, wherein the panel-specific P-MPRs of other panels are not reported; or
reporting more than one panel-specific P-MPRs of the different panels to the network.

10. The method of claim 1, wherein the PH is reported via medium access control (MAC) signalling, and an associated MAC Control Element (MAC CE) comprises at least one of the followings:
the UE-specific maximum power or the panel-specific maximum power(s),
the UE-specific PH or the panel-specific PH(s),
PH type indication(s) indicating whether the PH is actual or virtual,
UE-specific P-MPR or panel-specific P-MPR(s), or
P-MPR indication(s) indicating whether P-MPR is enabled or not.

11-22. (canceled)

23. A method of power headroom reporting for multi-panel simultaneous uplink transmissions, performed by a user equipment (UE) in a network, the method comprising:
being configured more than one panel-specific maximum powers of different panels; and
reporting one UE-specific power headroom (PH) of the UE or more than one panel-specific PHs of the different panels to the network,
wherein the UE-specific PH is a sum of the panel-specific maximum powers of the panels minus a sum of panel-specific scheduling powers of uplink (UL) transmissions on the panels, or wherein the panel-specific PH is the panel-specific maximum power of the panel minus the panel-specific scheduling power of the UL transmission on the panel.

24. The method of claim 23, wherein the PH is reported via medium access control (MAC) signalling, and an associated MAC Control Element (MAC CE) comprises at least one of the followings:
the UE-specific maximum power or the panel-specific maximum power(s),
the UE-specific PH or the panel-specific PH(s),
PH type indication(s) indicating whether the PH is actual or virtual,
UE-specific Power Management Maximum Power Reduction (P-MPR) or panel-specific P-MPR(s), or
P-MPR indication(s) indicating whether P-MPR is enabled or not.

25-26. (canceled)

27. A user equipment (UE), comprising a processor and a transmitter, wherein the processor is configured to call and run program instructions stored in a memory, to execute a method of power headroom reporting for multi-panel simultaneous uplink transmissions comprising:
being configured more than one panel-specific maximum powers of different panels; and
reporting one UE-specific power headroom (PH) of the UE or more than one panel-specific PHs of the different panels to the network,
wherein the UE-specific PH is a sum of the panel-specific maximum powers of the panels minus a sum of panel-specific scheduling powers of uplink (UL) transmissions on the panels, or wherein the panel-specific PH is the panel-specific maximum power of the panel minus the panel-specific scheduling power of the UL transmission on the panel.

28-30. (canceled)

31. The method of claim 23, further comprising:
computing a virtual panel-specific maximum power of the panel when various types of MPR are zero.

32. The UE of claim 27, wherein the PH is reported via medium access control (MAC) signalling, and an associated MAC Control Element (MAC CE) comprises at least one of the followings:
the UE-specific maximum power or the panel-specific maximum power(s),
the UE-specific PH or the panel-specific PH(s),
PH type indication(s) indicating whether the PH is actual or virtual,
UE-specific Power Management Maximum Power Reduction (P-MPR) or panel-specific P-MPR(s), or
P-MPR indication(s) indicating whether P-MPR is enabled or not.

33. The UE of claim 27, wherein the processor is configured to compute a virtual panel-specific maximum power of the panel when various types of MPR are zero.

34. The method of claim 1, further comprising:
computing a virtual panel-specific maximum power of the panel when various types of MPR are zero.
